(19) United States
(12) Patent Application Publication
(10) Pub. No.: US 2004/0130291 A1
(43) Pub. Date: Jul. 8, 2004

(54) Charger for wireless hand-held controller

(75) Inventor: Kent T. J. Hsu, Taipei (TW)

Correspondence Address: RABIN & BERDO, P.C., Suite 500, 1101 14 Street, N.W., Washington, DC, 20005, US

(73) Assignee: ASOKA INC., Taipei (TW)

(21) Appl. No.: 10/335,928

(22) Filed: Jan. 3, 2003

(51) Int. Cl. H02J 7/02

(52) U.S. Cl. 320/111

(57) ABSTRACT

A charger device for wireless hand-held controller is disclosed. The device comprises a DC charge socket, a contact coupled to a terminal of a rechargeable cell in a battery compartment, a charge IC electrically interconnected the DC charge socket and the contact, and an adapter for DC charging. In charging, insert the first and the second DC plugs in the DC charge jack and the DC charge socket respectively so that a required DC is automatically fetched by the charge IC from the control assembly to the cell via the contact. The invention can eliminate conventional charger seat and adapter, charge the controller without coupling to a USB port of computer and a charger jack of automobile, maintain a normal wireless signal transmission of the controller during charging, and maintain a good wireless signal transmission quality during charging by the provision of the charge IC.

### FIELD OF THE INVENTION

The present invention relates to chargers and more particularly to an improved charger for a wireless hand-held controller.

### BACKGROUND OF THE INVENTION

Video games have been popular among people especially young persons in recent years. Also, a variety of video game machines including hand-held ones have been developed for tailoring the needs of consumers in which wireless control hosts and wireless hand-held controllers are two important ones of them.

It is understood that a wireless device is typically powered by battery. It is also understood that the environment may be polluted if a consumed cell is not disposed properly. Thus, a rechargeable cell is desirable. Conventionally, one or more cells are anchored in a charger seat which is again coupled to an adapter prior to charging. However, the prior art charging arrangement suffered from several disadvantages. For example, the charger seat and the adapter are bulky and space occupying elements. It is understood that voltage used in the world is either about 110V or about 220V. Hence, a user has to carry at least two pairs of charger seat and adapter together with a hand-held video game machine while traveling abroad. In view of this, it is very inconvenient.

A proposed arrangement for charging a hand-held video game machine without a pair of charger seat and adapter is effected by coupling a charge transmission interface of the hand-held video game machine to a USB (Universal Serial Bus) port of a computer or a charger jack of an automobile. However, the proposed arrangement for charging may be compromised if neither the USB port of computer nor the charger jack of automobile is available. In other words, the user has to use the charger seat and the adapter for charging the video game machine in this condition. Hence, a need for improvement exists.

### SUMMARY OF THE INVENTION

It is therefore an object of the present invention to provide a charger for a wireless hand-held controller of a hand-held video game machine so as to eliminate the cost of buying a charger seat and an adapter.

In one aspect of the present invention, it is possible of charging the wireless hand-held controller, without a provision of a USB port of computer and a charger jack of automobile.

In another aspect of the present invention, a charging of rechargeable cells contained in a battery compartment of the wireless hand-held controller, does not affect a normal wireless signal transmission of the wireless hand-held controller.

In a further aspect of the present invention, wireless signal transmission quality is well maintained during charging by a provision of a charge IC on the charger.

The above and other objects, features and advantages of the present invention will become apparent from the following detailed description taken with the accompanying drawings.

### BRIEF DESCRIPTION OF THE DRAWINGS

FIG. 1 is a perspective view of control assembly and wireless hand-held controller of a hand-held video game machine where a charger device according to the invention is incorporated in the controller;

FIG. 2 is an exploded view of the controller of FIG. 1;

FIG. 3 is a top plan view of circuit board of FIG. 2; and

FIG. 4 is a view similar to FIG. 1 with an addition of an adapter for DC charging forming a charger equipment of wireless hand-held controller according to a preferred embodiment of the invention.

### DETAILED DESCRIPTION OF THE PREFERRED EMBODIMENTS

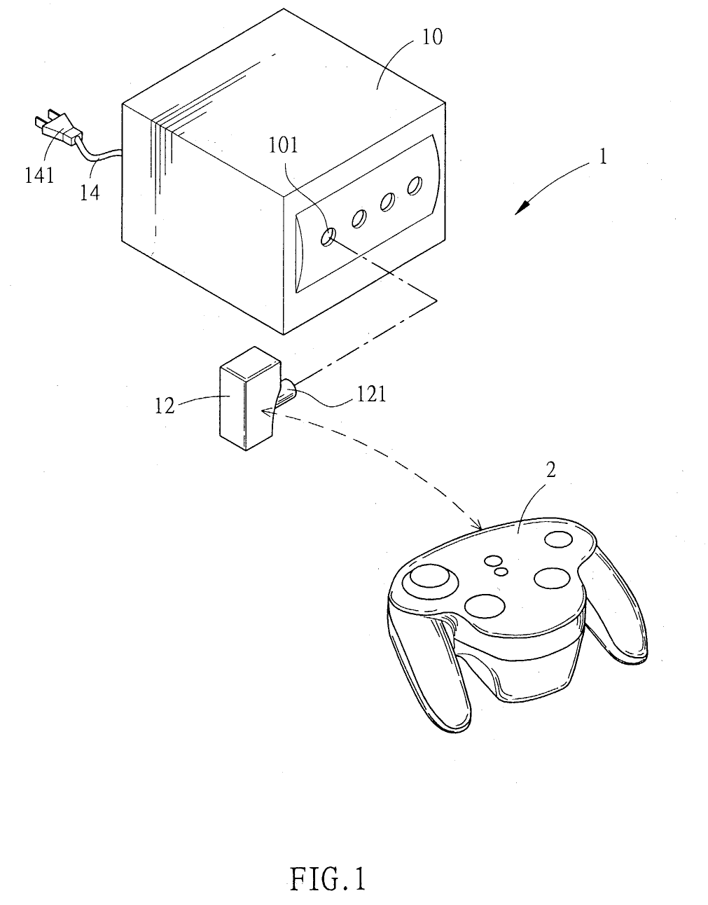

Referring to FIG. 1, there is shown a control assembly 1 and a wireless hand-held controller 2 of a hand-held video game machine in which a charger device according to the invention is incorporated in the controller 2. The control assembly 1 comprises a control host 10 and a wireless signal transmitter 12. A power cord 14 having a power plug 141 is extended from or coupled to the rear side of the control host 10. A transmission interfaces 101 is provided on the front side of the control host 10 in which the transmission interfaces 101 is coupled to a connector 121 of the wireless signal transmitter 12. A wireless signal transmitted from the controller 2 will be received by the wireless signal transmitter 12. The received wireless signal is then sent to the control host 10 via the connection of the connector 121 and the transmission interface 101. In response, a corresponding representation is displayed on a TV or computer monitor as instructed by the control host 10. Power of the control assembly 1 is supplied by the power cord 14 from an external power source (not shown). At the same time, power of the control host 10 is fed to the wireless signal transmitter 12 via the connection of the connector 121 and the transmission interface 101 for maintaining a normal operation of the wireless signal transmitter 12. As to the controller 2, it is powered by an internal battery.

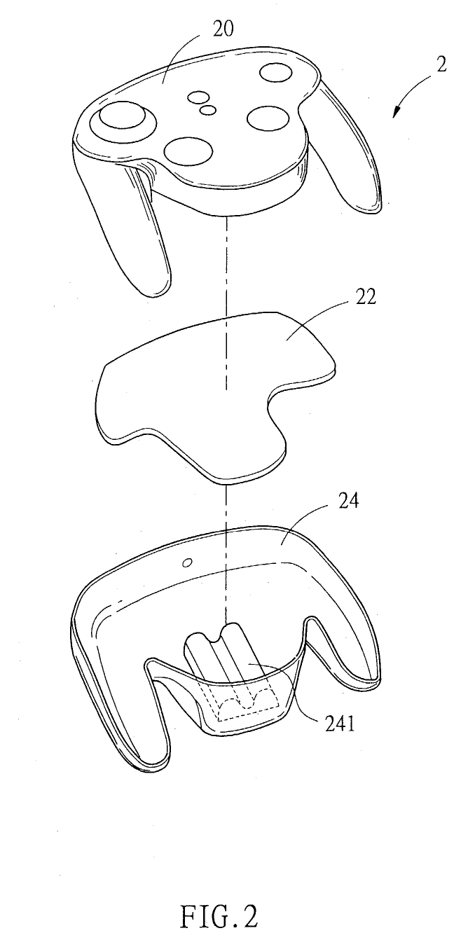

Referring to FIG. 2, the controller 2 comprises an upper housing 20, a mated lower housing 24, and a circuit board 22 enclosed by the upper and the lower housings 20, 24. The circuit board 22 comprises a circuitry and chips for generating and transmitting wireless signals. A battery compartment 241 is disposed in the lower housing 24. One or more rechargeable cells are placed in the battery compartment 241.

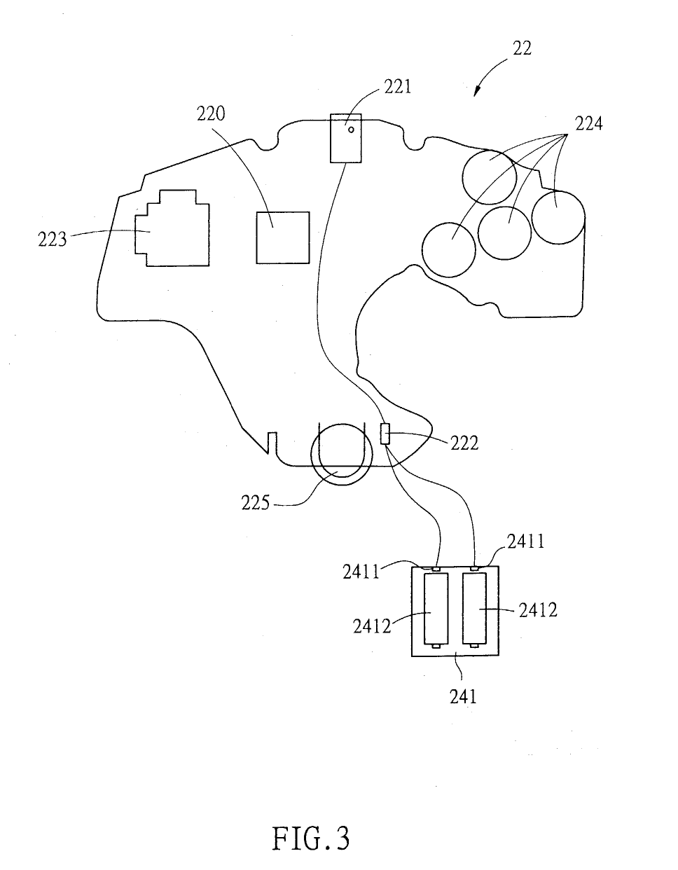

Referring to FIG. 3, a detailed description of components of the circuit board 22 will now be described. All charging elements of the charger device in accordance with the invention are provided on the circuit board 22. The charging elements comprise a DC (direct current) charge socket 221 at an edge of the circuit board 22, a plurality of contacts 2411 (two are shown), and a charge IC (integrated circuit) 222 electrically interconnecting the DC charge socket 221 and each of the contacts 2411. A MCU (microcontroller unit) 220 is provided for receiving trigger signals sent from a joystick circuit 223, a plurality of buttons 224, and a channel adjuster 225 also at the edge of the circuit board 22. And transfer the trigger signals into wireless signals which then transmit to the wireless signal transmitter 12 of the control assembly 1. For that, it could complete producing and transmitting signals in wireless form.

Each contact 2411 is provided at an edge of the battery compartment 241 in the embodiment or on the circuit board 22 to be coupled to a terminal of a cell 2412 placed in the battery compartment 241. The contacts 2411 are also electrically coupled to the cells 2412 in the battery compartment 241.

With the above connection of the charging elements, once DC is fed to the controller 2 via the DC charge socket 221, the charge IC 222 will automatically fetch DC and feed it to the cells 2412. Hence, it is important that a charging of the cells 2412 can be performed at the same time as a user uses the controller 2. Also, the charge IC 222 of the invention does not affect a normal wireless signal transmission. As a result, a wireless signal transmission quality between the control host 10 and the controller 2 is well maintained during charging.

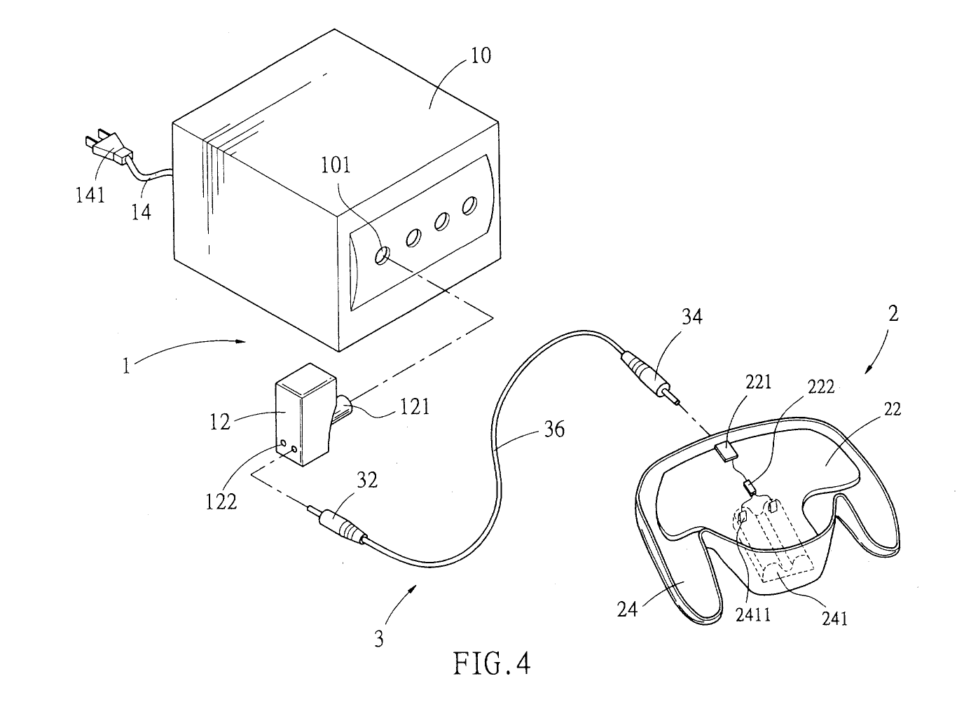

Referring to FIG. 4, a charger equipment of a wireless hand-held controller according to a preferred embodiment of the invention is shown. The charger equipment of the wireless hand-held controller comprises a control assembly 1, a wireless hand-held controller 2, and an adapter for DC charging 3.

The control assembly 1 comprises a control host 10 and a wireless signal transmitter 12. Also, the control host 10 and the wireless signal transmitter 12 are coupled together. Further, a power cord 14 having a power plug 141 is extended from or coupled to the rear side of the control host 10. Thus, working power is applied to the control host 10 as the power plug 141 is inserted in an outlet of a room. Moreover, the working power is converted into DC which is again fed to the wireless signal transmitter 12 via the connector 121 of the wireless signal transmitter 12.

A circuit board 22 is placed on a lower housing 24 of the controller 2. A battery compartment 241 is disposed in the lower housing 24. One or more rechargeable cells 2412 are placed in the battery compartment 241 for providing DC required for normal operation of the controller 2. Also, a contact 2411 is provided in the controller 2. The contact 2411 is electrically coupled to a terminal of the cell 2412. In addition, a DC charge socket 221 and a charge IC 222 are provided on the circuit board 22 in which the charge IC 222 is electrically coupled to the contact 2411 and the DC charge socket 221.

Additionally, as shown in FIG. 4, the adapter for DC charging 3 has two DC plugs 32, 34 at its ends and a connection line 36 interconnecting the DC plugs 32, 34.

With the above structure, in a charging operation first connect the power cord 141 to an outlet in a room for turning on the control host 10 and the wireless signal transmitter 12 which is coupled to the control host 10 by the connection of the connector 121 and the transmission interface 101. Next, insert the DC plug 32 in a DC charge jack 122 at one side of the wireless signal transmitter 12 and insert the DC plug 34 in the DC charge socket 221 respectively. The charging operation begins in which DC is automatically fetched by the charge IC 222 from the control assembly 1. Further, DC is charged to the cells 2412 via the contacts 2411 coupled to the terminals of the cells 2412.

As shown in FIG. 4, note that the DC charge jack 122 is provided on the front side of the wireless signal transmitter 12 in this embodiment. Hence, DC is fetched by the charge IC 222 from the control assembly 1 to the wireless signal transmitter 12 via the connector 121. Further, DC is automatically charged to the cells 2412 of the wireless signal transmitter 12 via the DC charge jack 122, the adapter for DC charging 3, and the DC charge socket 221. But the DC charge jack 122 can be provided on the front side of the control host 10 in this embodiment. Hence, the DC plug 32 may be inserted in the DC charge jack 122 on the control host 10 directly in the charging operation. It is further noted that the DC charge jack 122 may be provided on another device other than the control host 10 and the wireless signal transmitter 12 depending on applications.

In brief, the invention has the following advantages. First, the cost of buying a charger seat and an adapter is eliminated. Second, it is possible of charging the wireless hand-held controller without the provision of a USB port of computer and a charger jack of automobile. Third, a charging of the cells does not affect a normal wireless signal transmission of the wireless hand-held controller. Fourth, wireless signal transmission quality is well maintained during charging by the provision of the charge IC 222.

While the invention has been described by means of specific embodiments, numerous modifications and variations could be made thereto by those skilled in the art without departing from the scope and spirit of the invention set forth in the claims.

What is claimed is:

1. A charger device for a wireless hand-held controller, the charger device being used between a control assembly and the wireless hand-held controller, wherein the control assembly is coupled to a power cord having a power plug, and wireless hand-held controller includes a circuit board and a battery compartment for containing a rechargeable cell, the charger device comprising:
a DC charge jack at the control assembly;
a DC charge socket on the circuit board;
a contact electrically coupled to a terminal of the cell;
a charge IC on the circuit board and being electrically interconnected the DC charge socket and the contact; and
an adapter for DC charging having first and second DC plugs at its ends, wherein a connection line is interconnected the first and the second DC plugs;
wherein in an charging operation, insert the first and the second DC plugs in the DC charge jack of the control assembly and the DC charge socket of the circuit board respectively, so that a required DC is automatically fetched by the charge IC from the control assembly to the cell via the contact.

2. The charger device of claim 1, wherein the contact is provided on the circuit board.

3. The charger device of claim 1, wherein the contact is provided within the battery compartment.

4. The charger device of claim 1, wherein the control assembly comprises a control host and a wireless signal transmitter coupled to the control host.

5. The charger device of claim 4, wherein the DC charge jack is provided on the control host.

6. The charger device of claim 4, wherein the DC charge jack is provided on the wireless signal transmitter.

7. A charger element for a wireless hand-held controller including a circuit board and a battery compartment for containing a rechargeable cell, the wireless hand-held controller being operative for controlling an operation of a control assembly wherein the control assembly is coupled to a power cord having a power plug, the charger element comprising:
a DC charge socket on the circuit board;
a contact electrically coupled to a terminal of the cell; and
a charge IC on the circuit board and being electrically interconnected the DC charge socket and the contact;
wherein in an charging operation, a required DC is automatically fetched by the charge IC from the wireless hand-held controller to the cell via the contact, in response to a DC fed to the wireless hand-held controller via the DC charge socket.

8. The charger element of claim 7, wherein the contact is provided on the circuit board.

9. The charger element of claim 7, wherein the contact is provided within the battery compartment.

10. A charger equipment for a wireless hand-held controller, comprising:
a control assembly coupled to a power cord having a power plug;
a wireless hand-held controller including:
a battery compartment for containing a rechargeable cell;
a contact electrically coupled to a terminal of the cell;
a circuit board including:
a DC charge socket; and
a charge IC on the circuit board and being electrically interconnected the DC charge socket and the contact; and
an adapter for DC charging having first and second DC plugs at its ends wherein a connection line is interconnected the first and the second DC plugs;
wherein in an charging operation, insert the first and the second DC plugs in the DC charge jack of the control assembly and the DC charge socket of the circuit board respectively, so that a required DC is automatically fetched by the charge IC from the control assembly to the cell via the contact.

11. The charger equipment of claim 10, wherein the control assembly comprises a control host and a wireless signal transmitter coupled to the control host.

12. The charger equipment of claim 11, wherein the DC charge jack is provided on the control host.

13. The charger equipment of claim 11, wherein the DC charge jack is provided on the wireless signal transmitter.

14. The charger equipment of claim 10, wherein the contact is provided on the circuit board.

15. The charger equipment of claim 10, wherein the contact is provided within the battery compartment.
